(19) United States
(12) Patent Application Publication
(10) Pub. No.: US 2023/0147357 A1
(43) Pub. Date: May 11, 2023

(54) VEHICLE CONTROL SYSTEM, APPARATUS, AND METHOD

(71) Applicant: NEC Corporation, Minato-ku, Tokyo (JP)

(72) Inventors: Takanori IWAI, Tokyo (JP); Koichi NIHEI, Tokyo (JP); Kosei KOBAYASHI, Tokyo (JP); Yusuke SHINOHARA, Tokyo (JP); Takashi YAMANE, Tokyo (JP); Mssayuki SAKATA, Tokyo (JP)

(73) Assignee: NEC Corporation, Minato-ku, Tokyo (JP)

(21) Appl. No.: 17/911,783

(22) PCT Filed: Mar. 31, 2020
(86) PCT No.: PCT/JP2020/014936

§ 371 Date: Sep. 15, 2022

(51) Int. Cl. B60W 60/00

(52) U.S. Cl. CPC B60W 60/001; B60W 2555/00; B60W 2530/00

(57) ABSTRACT

A vehicle control unit controls automated driving of a target vehicle on the basis of first information obtained by a sensor of the target vehicle. An analysis unit analyzes state information of the target vehicle on the basis of the first information obtained by the sensor of the target vehicle, and second information obtained by a sensor outside the target vehicle. A specification unit specifies a control policy of the target vehicle on the basis of the analyzed state information.

### TECHNICAL FIELD

The present disclosure relates to a vehicle control system, an apparatus, a method, and a computer-readable medium.

### BACKGROUND ART

As a related art, Patent Literature 1 discloses a vehicle driving assistance system that assists in driving a vehicle. In the vehicle driving assistance system described in Patent Literature 1, a vehicle obtains driving information or traffic information from another vehicle or an on-road facility by using inter-vehicle communication or road-vehicle communication. A driving control unit of the vehicle controls automated driving of the vehicle on the basis of information obtained from the other vehicle or the on-road facility and information relating to a driving situation of the vehicle that has been obtained from a sensor of the local vehicle.

As another related art, Patent Literature 2 discloses an automated traveling assistance system. In the automated traveling assistance system described in Patent Literature 1, a vehicle detects an obstacle on the road by using an obstacle sensor. The vehicle reports the detection of the obstacle to a roadside control apparatus (a centralized base station) by using road-vehicle communication. The roadside control apparatus analyzes a situation of the obstacle by using a roadside sensor. The roadside control apparatus generates avoidance action instruction information on the basis of a result of analysis, and transmits the avoidance action instruction information to the vehicle serving as an obstacle report source and a vehicle around the vehicle. The vehicle that has received the avoidance action instruction information performs an operation to avoid the obstacle in accordance with the content of the avoidance action instruction information.

### CITATION LIST

### Patent Literature

Patent Literature 1: Japanese Unexamined Patent Application Publication No. 2018-077652
Patent Literature 2: Japanese Unexamined Patent Application Publication No. 2000-306194

### SUMMARY OF INVENTION

### Technical Problem

In Patent Literature 1, for example, in a case where a vehicle passes another vehicle, the vehicle starts inter-vehicle communication with the other vehicle. The vehicle obtains, from the other vehicle, information indicating an avoidance direction, and determines an avoidance direction of the local vehicle in accordance with the obtained information. However, in Patent Literature 1, automated driving of the vehicle is performed on the basis of sensor information of the local vehicle. Therefore, the vehicle fails to handle a potential risk that fails to be recognized by only using a sensor of the local vehicle.

In Patent Literature 2, in a case where the detection of an obstacle has been reported from a vehicle, the roadside control apparatus analyzes a situation of the obstacle by using the roadside sensor, and generates avoidance action instruction information on the basis of a result of analysis. Each vehicle avoids the obstacle in accordance with the avoidance action instruction information, and therefore a safer obstacle avoidance operation can be performed with time to spare in comparison with a case where each of the vehicles performs autonomous traveling by only relying on a sensor mounted on the local vehicle. However, the roadside control apparatus analyzes an obstacle on the basis of only an image captured by the roadside sensor. Therefore, the roadside control apparatus does not always perform an analysis suitable for control performed on each of the vehicles.

In view of the circumstances described above, it is an object of the present disclosure to provide a vehicle control system, an apparatus, a method, and a computer-readable medium that are capable of more precisely determining a situation of a vehicle and controlling automated driving of the vehicle on the basis of the situation of the vehicle.

### Solution to Problem

In order to achieve the object described above, the present disclosure provides a vehicle control system including: vehicle control means for controlling a target vehicle on the basis of first information obtained by a sensor that is provided in the target vehicle; analysis means for analyzing state information of the target vehicle on the basis of the first information received via a network, and second information obtained from a sensor that is provided outside the target vehicle; and specification means for specifying a control policy of the target vehicle on the basis of the state information analyzed by the analysis means.

The present disclosure provides a vehicle control apparatus including: analysis means for analyzing state information of a target vehicle on the basis of first information and second information, the target vehicle being driven in an automated manner on the basis of the first information that has been obtained by a sensor that is provided in the target vehicle, the first information having been received via a network from the target vehicle, the second information having been obtained from a sensor that is provided outside the target vehicle; and specification means for specifying a control policy of the target vehicle on the basis of the state information analyzed by the analysis means.

The present disclosure provides a vehicle control method including: analyzing state information of a target vehicle on the basis of first information and second information, the target vehicle being controlled on the basis of the first information that has been obtained by a sensor that is provided in the target vehicle, the first information having been received via a network from the target vehicle, the second information having been obtained from a sensor that is provided outside the target vehicle; and specifying a control policy of the target vehicle on the basis of the state information that has been analyzed.

The present disclosure provides a non-transitory computer-readable medium configured to store a program that causes a computer to perform a process including: analyzing state information of a target vehicle on the basis of first information and second information, the target vehicle being controlled on the basis of the first information that has been obtained by a sensor that is provided in the target vehicle, the first information having been received via a network from the target vehicle, the second information having been obtained from a sensor that is provided outside the target vehicle; and specifying a control policy of the target vehicle on the basis of the state information that has been analyzed.

### Advantageous Effects of Invention

A vehicle control system, an apparatus, a method, and a computer-readable medium according to the present disclosure are capable of more precisely determining a situation of a vehicle and assisting in driving the vehicle on the basis of the situation of the vehicle.

### BRIEF DESCRIPTION OF DRAWINGS

FIG. 1 is a block diagram schematically illustrating a vehicle control system according to the present disclosure.

FIG. 2 is a flowchart schematically illustrating an operation procedure in the vehicle control system according to the present disclosure.

FIG. 3 is a block diagram illustrating a vehicle control system according to a first example embodiment of the present disclosure.

FIG. 4 is a block diagram illustrating an example of a configuration of a vehicle to be controlled.

FIG. 5 is a flowchart illustrating an operation procedure in the vehicle control system.

FIG. 6 is a block diagram illustrating a vehicle control system according to a second example embodiment of the present disclosure.

FIG. 7 is a block diagram illustrating a vehicle that is used in a vehicle control system according to a third example embodiment of the present disclosure.

FIG. 8 is a block diagram illustrating a control center that is used in the vehicle control system according to the third example embodiment of the present disclosure.

FIG. 9 is a block diagram illustrating an example of a configuration of a computer apparatus.

### EXAMPLE EMBODIMENT

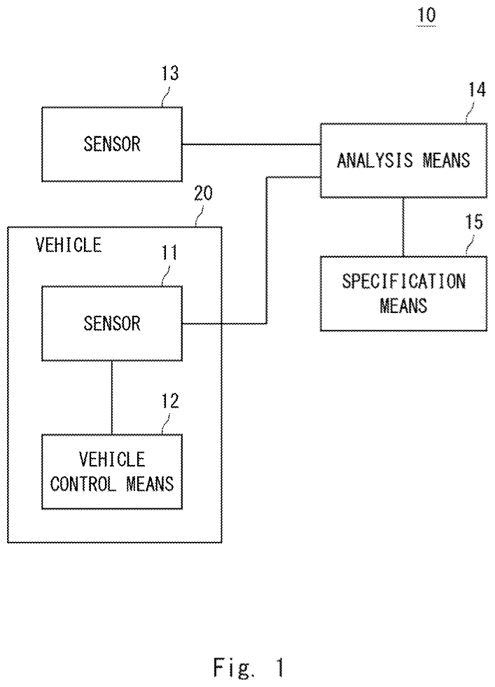

Prior to the description of an example embodiment of the present disclosure, an outline of the present disclosure is described. FIG. 1 schematically illustrates a vehicle control system according to the present disclosure. A vehicle control system 10 includes vehicle control means 12, analysis means 14, and specification means 15. A sensor 11 is disposed in a vehicle 20 serving as a target vehicle. The vehicle control means 12 controls the vehicle 20 on the basis of first information obtained by the sensor 11. The first information obtained by the sensor 11 is transmitted to the analysis means 14 via a network.

A sensor 13 is a sensor that is disposed outside the target vehicle. The analysis means 14 analyzes state information of the vehicle 20 on the basis of the first information obtained by the sensor 11 and second information obtained by the sensor 13. The specification means 15 specifies a control policy of the vehicle 20 on the basis of the state information analyzed by the analysis means 14.

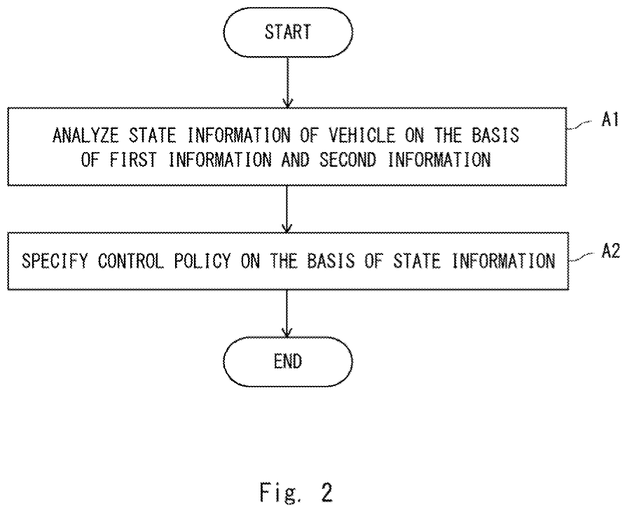

FIG. 2 schematically illustrates an operation procedure in the vehicle control system 10. The analysis means 14 analyzes the state information of the vehicle 20 on the basis of the first information that has been obtained by the sensor 11 provided in the vehicle 20 and has been received via the network, and the second information that has been obtained from the sensor 13 provided outside the target vehicle (step A1). The specification means 15 specifies a control policy of the vehicle 20 on the basis of the analyzed state information (step A2).

In the present disclosure, the analysis means 14 analyzes the state information of the vehicle 20 on the basis of the sensor 11 of the vehicle 20 and the sensor 13 outside the target vehicle. The specification means 15 specifies a control policy of automated driving of the vehicle 20 on the basis of the analyzed state information. The vehicle control means 12 controls the vehicle 20 on the basis of the specified control policy. In the present disclosure, the control policy is specified by using the sensor 13 outside the target vehicle in addition to the sensor 11 of the vehicle 20. By doing this, a situation of the vehicle 20 can be determined more precisely, and driving of the target vehicle can be assisted in on the basis of the situation of the vehicle.

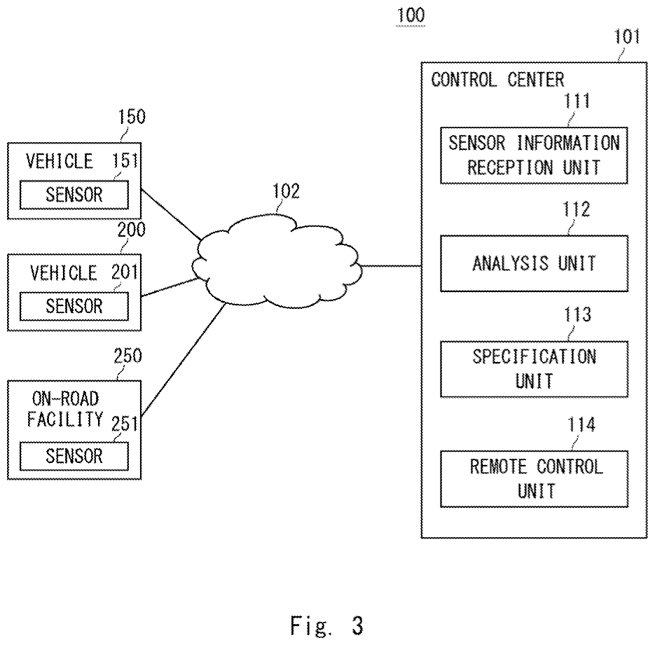

An example embodiment of the present disclosure is described in detail below with reference to the drawings. FIG. 3 illustrates a vehicle control system according to a first example embodiment of the present disclosure. A vehicle control system 100 includes a control center (a vehicle control apparatus) 101, a vehicle 150, a vehicle 200, and an on-road facility 250. In the vehicle control system 100, the control center 101 is connected to the vehicle 150, the vehicle 200, and the on-road facility 250 via a network 102. The network 102 may be, for example, a network in conformity with communication line standards such as long term evolution (LTE), or may include a wireless communication network such as Wi-Fi (registered trademark) or a fifth generation mobile communication system.

Note that FIG. 3 illustrates a single vehicle 200 and a single on-road facility 250, but the present example embodiment is not limited to this. In the present example embodiment, the vehicle control system 100 can include a plurality of vehicles 200. In addition, the vehicle control system 100 can include a plurality of on-road facilities 250. The vehicle control system 100 does not necessarily include both the vehicle 200 and the on-road facility 250, and it is sufficient if at least one of the vehicle 200 or the on-road facility 250 is included.

The vehicle 150 is a vehicle serving as a target to be controlled by the control center 101. The vehicle 150 is, for example, a vehicle that travels on the road, such as a private car, a taxi, or a bus. The vehicle 150 includes a sensor 151. The vehicle 150 is configured to be able to perform automated driving (autonomous driving) by using sensor information obtained by the sensor 151. The vehicle 150 transmits the sensor information obtained by the sensor 151, to the control center 101 via the network 102. The sensor 151 corresponds to the sensor 11 illustrated in FIG. 1.

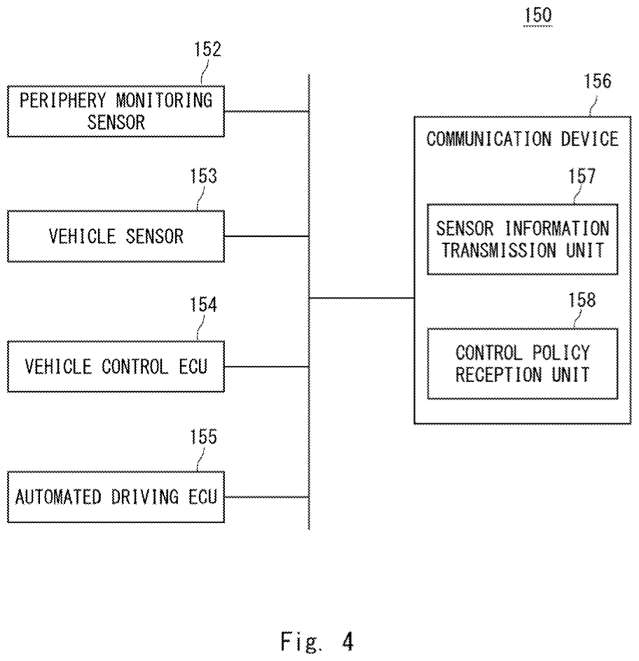

FIG. 4 illustrates an example of a configuration of the vehicle 150. The vehicle 150 includes a periphery monitoring sensor 152, a vehicle sensor 153, a vehicle control electric control unit (ECU) 154, an automated driving ECU 155, and a communication device 156. In the vehicle 150, these components are configured to be mutually communicable via an in-vehicle local area network (LAN).

The periphery monitoring sensor 152 is a sensor that monitors a peripheral situation of the vehicle 150. The periphery monitoring sensor 152 includes, for example, a camera, a radar, light detection and ranging (LiDAR), and the like. The periphery monitoring sensor 152 may include a plurality of cameras that images, for example, a front side, a rear side, a right-hand side, and a left-hand side of the vehicle.

The vehicle sensor 153 is a sensor for detecting various states of the vehicle 150. The vehicle sensor 153 includes sensors, for example, a vehicle speed sensor that detects vehicle speed, a steering sensor that detects a steering angle, an accelerator opening sensor that detects the opening of an accelerator pedal, a brake depression sensor that detects an amount of depression of a brake pedal, and the like. The periphery monitoring sensor 152 and the vehicle sensor 153 correspond to the sensor 151 illustrated in FIG. 3.

The vehicle control ECU 154 is an electronic control unit that performs traveling control or the like on the vehicle 150. In general, the electronic control unit includes a processor, a memory, an input/output (I/O), and a bus that connects them. The vehicle control ECU 154 performs various types of control, such as control performed on a fuel injection amount, control performed on an engine injection timing, or control performed on a power steering assistance amount, on the basis of sensor information that has been output by the vehicle sensor 153.

The automated driving ECU 155 is an electronic control unit that controls automated driving of the vehicle 150. The automated driving ECU 155 obtains sensor information from the periphery monitoring sensor 152 and the vehicle sensor 153, and controls autonomous traveling of the vehicle 150 on the basis of the obtained sensor information. Automated driving performed by the automated driving ECU 155 can be controlled by the control center 101 by using the control policy described later. The automated driving ECU 155 corresponds to the vehicle control means 12 illustrated in FIG. 1.

The communication device 156 is configured as a device that performs wireless communication between the vehicle 150 and the network 102 (see FIG. 3). The communication device 156 includes an antenna for wireless communication, a transmitter, and a receiver. In addition, the communication device 156 includes a processor, a memory, an I/O, and a bus that connects them. The communication device 156 includes, as a logical component, a sensor information transmission unit 157 and a control policy reception unit 158. Functions of the sensor information transmission unit 157 and the control policy reception unit 158 are implemented, for example, by executing a control program stored in the memory by using a microcomputer.

The sensor information transmission unit 157 obtains, via the in-vehicle LAN, sensor information that has been obtained by the periphery monitoring sensor 152 and the vehicle sensor 153. The sensor information transmission unit 157 does not necessarily need to obtain all pieces of sensor information of the periphery monitoring sensor 152 and the vehicle sensor 153 that will be used by the automated driving ECU 155. The sensor information transmission unit 157 may obtain some pieces of sensor information that have been obtained by the periphery monitoring sensor 152 and the vehicle sensor 153. The sensor information obtained by the sensor information transmission unit 157 can include image data that has been obtained by imaging a front side, a rear side, a left-hand side, and a right-hand side of the vehicle by using cameras. The sensor information transmission unit 157 transmits the obtained sensor information to the control center 101 via the network 102.

The control policy reception unit 158 receives a control policy from the control center 101. In a case where the control policy has been received, the control policy reception unit 158 transmits the received control policy to the automated driving ECU 155 via the in-vehicle LAN. In a case where the control policy has been received, the automated driving ECU 155 controls (modifies), on the basis of the received control policy, automated driving of the vehicle 150 that is performed on the basis of the sensor information of the periphery monitoring sensor 152 and the vehicle sensor 153.

Referring back to FIG. 3, the vehicle 200 is a vehicle that is different from the vehicle 150 to be controlled. The vehicle 200 includes a sensor 201. The vehicle 200 is, for example, a vehicle that travels on the road, such as a private car, a taxi, or a bus. The vehicle 200 transmits sensor information obtained by the sensor 201, to the control center 101 via the network 102. A configuration of the vehicle 200 may be a configuration obtained by omitting the automated driving ECU 155 and the control policy reception unit 158 from the configuration illustrated in FIG. 4 of the vehicle 150. The sensor 201 is configured as a sensor that is equivalent to the periphery monitoring sensor 152 illustrated in FIG. 4.

The on-road facility 250 is a facility that has been installed on the road, such as a traffic light, a traffic sign, or a street light. The on-road facility 250 includes a sensor 251. The on-road facility 250 transmits sensor information obtained by the sensor 251, to the control center 101 via the network 102. A configuration of the on-road facility 250 may be a configuration obtained by omitting the vehicle sensor 153, the vehicle control ECU 154, the automated driving ECU 155, and the control policy reception unit 158 from the configuration illustrated in FIG. 4 of the vehicle 150. The sensor 251 is configured as a sensor that is equivalent to the periphery monitoring sensor 152 illustrated in FIG. 4. The sensors 201 and 251 correspond to the sensor 13 illustrated in FIG. 1.

The control center 101 includes a sensor information reception unit 111, an analysis unit 112, a specification unit 113, and a remote control unit 114. The sensor information reception unit 111 receives sensor information (first information) that has been obtained by the sensor 151, from the vehicle 150 to be controlled. In addition, the sensor information reception unit 111 receives pieces of sensor information (second information) that have been obtained by the sensors 201 and 251, from the vehicle 200 that is not a target to be controlled, and the on-road facility 250. Note that the sensor information reception unit 111 does not necessarily need to receive sensor information from both the vehicle 200 and the on-road facility 250. It is sufficient if the sensor information reception unit 111 receives sensor information from at least one of the vehicle 200 or the on-road facility 250.

The analysis unit 112 analyzes state information of the vehicle 150 to be controlled, on the basis of the sensor information of the sensor 151 and the pieces of sensor information of the sensors 201 and 251 that have been received by the sensor information reception unit 111. The state information of the vehicle 150 includes, for example, an operation state of the vehicle 150 and peripheral information of the vehicle 150. The operation state of the vehicle includes information relating to a traveling state of the vehicle 150 itself. The operation state can include, for example, information relating to the availability of automated driving, a place where the vehicle travels, and the like. The peripheral information includes information relating to a phenomenon that can affect the traveling of the vehicle 150 in the circumference of the vehicle 150. Here, the “circumference of a vehicle” can include, for example, a range of several meters with the vehicle 150 as a center, a line-of-sight distance in which the camera of the vehicle 150 can capture an image, an intersection that is one ahead of a traveling location of the vehicle, a place on a route of the vehicle 150, and the like. The peripheral information can include, for example, information relating to the presence/absence of a pedestrian, the presence/absence of another risky vehicle, the absence/presence of traffic obstruction on the road, and the like. The analysis unit 112 analyzes each of the sensor information of the sensor 151 and the pieces of sensor information of the sensors 201 and 251. The analysis unit 112 may analyze a plurality of states relating to each of the operation state of the vehicle and the peripheral information. The analysis unit 112 analyzes the state information of the vehicle 150 on the basis of a result of analysis. The analysis unit 112 may include, for example, plural pieces of artificial intelligence (AI) that correspond to plural states to be analyzed, may input sensor information to each of the plural pieces of AI, and may obtain a result of analysis.

For example, the analysis unit 112 analyzes information relating to a pedestrian around the vehicle 150, as the peripheral information. The analysis unit 112 detects, for example, a person from the sensor information, and analyzes whether a person is present or whether a person is crossing the crosswalk, is walking on the sidewalk, or is crossing a place other than the crosswalk. In addition, the analysis unit 112 detects a vehicle from the sensor information, and analyzes whether an emergency vehicle is present, whether a truck is present, whether a vehicle that is speeding up or speeding down is present, or whether a vehicle is traveling in a meandering manner. The analysis unit 112 may analyze whether a bicycle, a motorcycle, or a construction site is present on the basis of the sensor information, or may analyze, for example, whether it is crowded. The analysis unit 112 may analyze whether the vehicle 150 is in a risky state on the basis of, for example, a combination of results of analyzing a plurality of items (states). The analysis unit 112 corresponds to the analysis means 14 illustrated in FIG. 1.

The sensor information reception unit 111 may receive the sensor information from all of the sensors 201 of the vehicles 200 that are not a target to be controlled, and the sensors 251 of the on-road facilities 250. The analysis unit 112 may analyze all pieces of sensor information that have been received by the sensor information reception unit 111, and may analyze pieces of state information relating to places where the vehicles 200 and the on-road facilities 250 are present. The analysis unit 112 may analyze the state information of the vehicle 150 on the basis of a result of analyzing the state information relating to each of the places, and a current location, a destination, a route, or the like of the vehicle 150 to be controlled. For example, in a case where a spot that the vehicle 150 is traveling toward is crowded, the analysis unit 112 may conduct an analysis to determine that the vehicle 150 will enter into a risky state.

In analyzing the state information of the vehicle 150 to be controlled, the analysis unit 112 may analyze sensor information that satisfies a specified condition from among collected pieces of sensor information instead of analyzing all of the collected pieces of sensor information. For example, the analysis unit 112 obtains location information of the vehicle 150 from the vehicle 150, or specifies a route of the vehicle 150 from information relating to a destination, or the like. The analysis unit 112 may analyze pieces of sensor information of a vehicle 200 and an on-road facility 250 that are located around the vehicle 150 to be controlled, or pieces of sensor information of a vehicle 200 and an on-road facility 250 that relate to a traveling direction, from among other vehicles 200 and the on-road facilities 250.

The analysis unit 112 may perform object detection on pieces of sensor information of other vehicles 200 and the on-road facilities 250. The analysis unit 112 may analyze pieces of sensor information of a vehicle 200 and an on-road facility 250 in which an object that attention is to be paid to, such as a vehicle, a child, or a fallen object, has been detected from the sensor information, from among other vehicles 200 and the on-road facilities 250, and may analyze the state information of the vehicle 150. Alternatively, the analysis unit 112 may track pieces of sensor information of other vehicles 200 and the on-road facilities 250, and may determine a portion having a large movement. The analysis unit 112 may analyze sensor information having a large movement from among pieces of sensor information of other vehicles 200 and the on-road facilities 250, and may analyze the state information of the vehicle 150.

The sensor information reception unit 111 does not need to receive sensor information from all of the vehicles 200 and the on-road facilities 250 in the same period, and may change a period of obtaining the sensor information depending on the vehicle 200 and the on-road facility 250. For example, in a case where sensor information satisfies a specified condition, the sensor information reception unit 111 may receive the sensor information from the vehicle 200 and the on-road facility 250 in a relatively short period, for example, a period of 100 milliseconds. In a case where sensor information does not satisfy a specified condition, the sensor information reception unit 111 may receive the sensor information from the vehicle 200 and the on-road facility 250 in a relatively long period, for example, a period of 1 second. In a case where a result of analyzing sensor information indicates a particularly risky state, the sensor information reception unit 111 may receive the sensor information from the vehicle 200 and the on-road facility 250 in a shorter period, for example, a period of 10 milliseconds.

The specification unit 113 specifies a control policy of the vehicle 150 to be controlled on the basis of the state information analyzed by the analysis unit 112. The specification unit 113 may specify a control policy that corresponds to the state information analyzed by the analysis unit 112, by using, for example, a table in association with the state information and a control policy to be applied. Alternatively, the specification unit 113 may specify a control policy from the state information by using a neural network. The specification unit 113 corresponds to the specification means 15 illustrated in FIG. 1.

The remote control unit (control policy transmission means) 114 transmits the control policy specified by the specification unit 113 to the vehicle 150 to be controlled via the network 102. The transmitted control policy is received by the control policy reception unit 158 (see FIG. 4) of the vehicle 150, and is transmitted to the automated driving ECU 155. The automated driving ECU 155 controls automated driving in accordance with the control policy. The remote control unit 114 transmits the control policy to the vehicle 150, and therefore the remote control unit 114 causes the vehicle 150 to perform automated driving based on the transmitted control policy.

The control policy is information indicating a policy of control to be applied to automated driving of a vehicle. The control policy has, for example, a hierarchical structure including a plurality of layers, and a highest layer provides an abstract instruction to a vehicle. In the control policy, a lower layer provides a more specific instruction to a vehicle.

For example, in automated driving of the vehicle 150, the vehicle travels at a highest speed and a highest acceleration that correspond to a safety level that has been determined on a vehicle side. In a case where the safety level is low, a highest speed in automated driving is set to a relatively low speed, for example, 20 km/h. In addition, a maximum acceleration is set to a relatively low value. The control center 101 obtains at least one of the sensor information of the vehicle 200 or the sensor information of the on-road facility 250 in addition to the sensor information of the vehicle 150, and analyzes state information of the vehicle 150. In a case where there are no pedestrians or the like in the circumference of the vehicle 150 and in a case where congestion has not been recognized in a traveling direction, the control center 101 transmits, to the vehicle 150, a control policy for setting, for example, a safety level that is higher by one stage. In this case, in the vehicle 150, the safety level can be increased by one stage, and automated driving can be performed in a state where a highest speed has been set to, for example, 30 km/h. The control policy may include a specific instruction to be provided to a vehicle, such as whether the vehicle 150 to be controlled may start or not. The control policy may include an instruction to change a priority order of a policy to be applied in automated driving on a side of the vehicle 150.

The automated driving ECU 155 of the vehicle 150 determines whether automated driving is available, by using sensor information of the periphery monitoring sensor 152, or the like. The control center 101 can determine whether automated driving of the vehicle 150 is available, by using sensor information of the vehicle 150 and sensor information of another vehicle 200 or the on-road facility 250, separately from determination performed in the vehicle 150 as to whether automated driving is available. Even in a case where the automated driving ECU 155 has determined that automated driving will be able to be continued, when state information analyzed by the analysis unit 112 indicates that automated driving will fail to be continued, the control center 101 transmits, to the vehicle 150, a control policy indicating switching from automated driving to remote control. The vehicle 150 requests the control center 101 to remotely drive the vehicle, in accordance with the control policy. The control center 101 that has received a request transmits, for example, a control command to the vehicle 150, and causes the vehicle 150 to perform an operation to avoid an obstacle. Alternatively, in the control center 101, a remote driver may operate a steering wheel, an accelerator pedal, or the like, and the control center 101 may transmit, to the vehicle 150, an amount of an operation performed on the steering wheel, the accelerator pedal, or the like, and therefore the vehicle 150 may be remotely maneuvered. By doing this, for example, before the vehicle 150 reaches a place where it has been determined that automated driving is not available, the control center 101 can switch the vehicle 150 to remote control in advance.

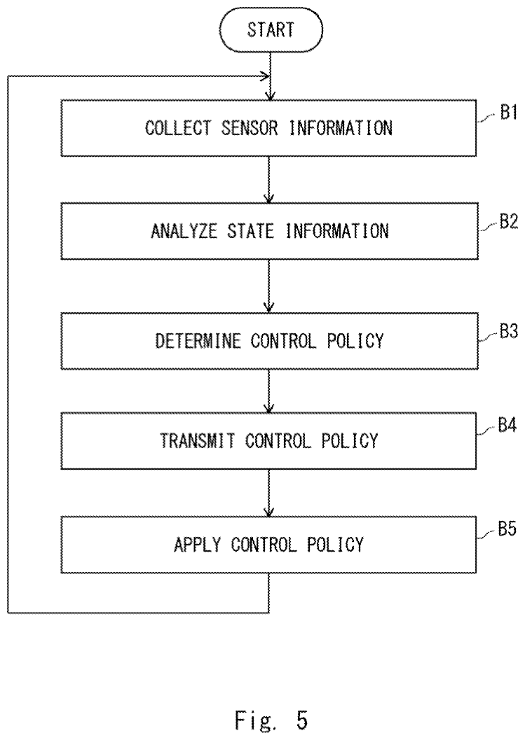

Next, an operation procedure (a vehicle control method) in the vehicle control system 100 is described. FIG. 5 illustrates the operation procedure in the vehicle control system 100. The vehicle 150 to be controlled performs automated driving on the basis of sensor information obtained by the sensor 151 (the periphery monitoring sensor 152 and the vehicle sensor 153 (see FIG. 4)). The vehicle 150 transmits the sensor information obtained by the sensor 151, to the control center 101 via the network 102. Another vehicle 200 that is not a target to be controlled and the on-road facility 250 respectively transmit pieces of sensor information obtained by the sensors 201 and 251, to the control center 101 via the network 102.

The sensor information reception unit 111 of the control center 101 collects sensor information from the vehicle 150, the vehicle 200, and the on-road facility 250 (step B1). The analysis unit 112 analyzes state information of the vehicle 150 on the basis of the collected pieces of sensor information (step S2). The specification unit 113 determines a control policy on the basis of the state information of the vehicle 150 (step S3). The remote control unit 114 transmits the determined control policy to the vehicle 150 via the network 102 (step S4).

The control policy reception unit 158 of the vehicle 150 receives the control policy transmitted from the control center 101. The automated driving ECU 155 obtains the control policy from the control policy reception unit 158. The automated driving ECU 155 applies the obtained control policy to automated driving (step S5). The automated driving ECU 155 controls automated driving of the vehicle on the basis of the control policy. The remote control unit 114 may transmit, to the vehicle, information in which the control policy can be selected on a vehicle side instead of the control policy itself. The vehicle 150 may receive the information, and may select the control policy.

In the present example embodiment, the control center 101 analyzes state information of a vehicle on the basis of sensor information of the vehicle 150 to be controlled and pieces of sensor information of the vehicle 200 that is not a target to be controlled and the on-road facility 250, and specifies a control policy on the basis of the state information. The control center 101 transmits the specified control policy to the vehicle 150, and therefore automated driving of the vehicle 150 is controlled. In the present example embodiment, pieces of sensor information of the vehicle 200 that is not a target to be controlled and the on-road facility 250 are used to control automated driving of the vehicle 150. The control center 101 can more precisely analyze state information of the vehicle 150 to be controlled in comparison with a case where the state information is analyzed on the basis of only the sensor information of the vehicle 150 to be controlled. Therefore, the control center 101 can appropriately control automated driving of the vehicle 150 in accordance with a situation of the vehicle.

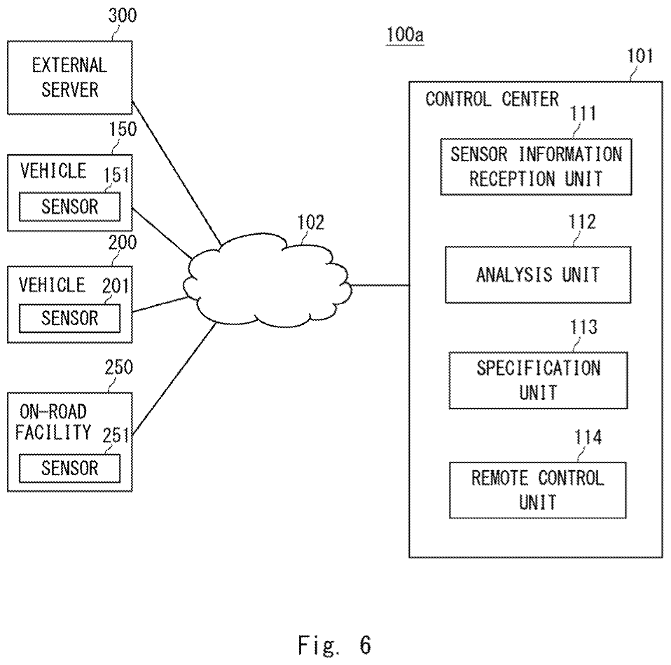

Next, a second example embodiment of the present disclosure is described. FIG. 6 illustrates a vehicle control system according to the second example embodiment of the present disclosure. A vehicle control system 100a according to the present example embodiment includes an external server 300 in addition to the configuration illustrated in FIG. 3 of the vehicle control system 100 according to the first example embodiment. The control center 101 can perform communication with the external server 300 via the network 102. In the present example embodiment, the analysis unit 112 uses information obtained from the external server 300 to analyze state information of the vehicle 150. Other points may be similar to points in the first example embodiment.

The external server 300 transmits, to the control center 101, information (third information) relating to an area where the vehicle 150 to be controlled is present. The information transmitted by the external server 300 includes, for example, information that can affect traffic in the area where the vehicle 150 to be controlled is present. The external server 300 transmits information, such as traffic congestion information, weather information, or an event situation, to the control center 101. The analysis unit 112 analyzes the state information of the vehicle 150 on the basis of the information obtained from the external server 300 in addition to sensor information of the sensor 151 of the vehicle 150 to be controlled and pieces of sensor information of the sensors 201 and 251 of the vehicle 200 that is not a target to be controlled and the on-road facility 250.

The analysis unit 112 analyzes whether an event is being held in a traveling direction of the vehicle 150, for example, on the basis of the event situation obtained from the external server 300. For example, in a case where an event is being held in a spot that the vehicle 150 will travel toward, it is predicted that a large number of persons will gather. Therefore, the analysis unit 112 may conduct an analysis to determine that the vehicle 150 will enter into a risky state. Alternatively, in a case where the weather information obtained from the external server 300 indicates rain, snow, or the like, the analysis unit 112 may conduct an analysis to determine that the vehicle 150 will enter into a risky state. The specification unit 113 specifies a control policy on the basis of the state information of the vehicle 150. The remote control unit 114 transmits the specified control policy to the vehicle 150, and controls automated driving in the vehicle 150.

In the present example embodiment, the analysis unit 112 analyzes the state information of the vehicle 150 to be controlled, by using the information obtained from the external server 300 in addition to pieces of sensor information of another vehicle 200 and the on-road facility 250. By doing this, a variety of pieces of state information of a vehicle can be analyzed in comparison with a case where only sensor information is used. Other effects are similar to effects exhibited in the first example embodiment.

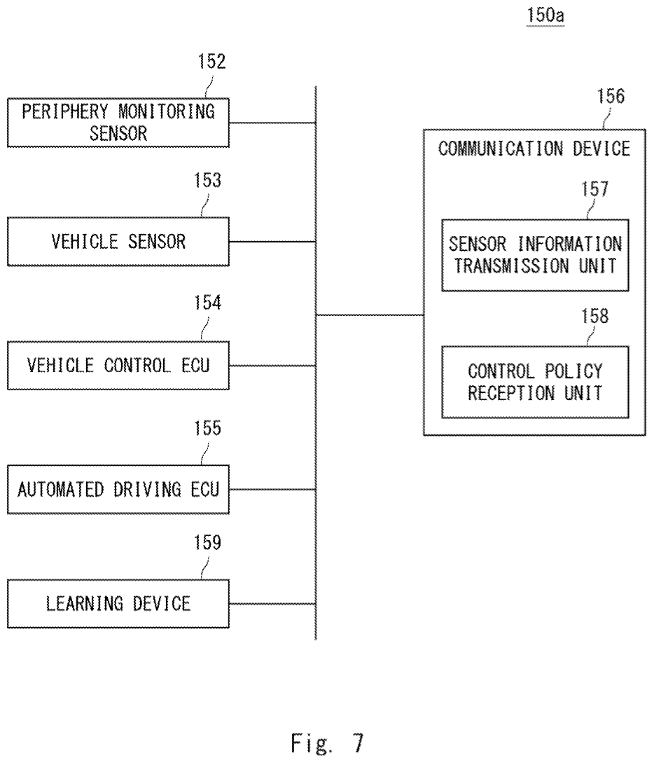

Next, a third example embodiment of the present disclosure is described. FIG. 7 illustrates a vehicle that is used in a vehicle control system according to the third example embodiment of the present disclosure. In the present example embodiment, a vehicle 150a includes a learning device 159 in addition to the components illustrated in FIG. 4 of the vehicle 150. The learning device (a first learning device) 159 leans a rule (a first rule) relating to automated driving controlled by the automated driving ECU 155.

It is assumed, for example, that in a video obtained by the periphery monitoring sensor 152, a person has been present in a specified area, and then the person has crossed the road. In this case, the learning device 159 learns a rule in which speed will be reduced in a case where a person is present in a specified region. Alternatively, the learning device learns a rule in which speed will be reduced in a case where the traffic light has started blinking. The automated driving ECU 155 controls automated driving on the basis of pieces of sensor information obtained from the periphery monitoring sensor 152 and the vehicle sensor 153, and the learned rule.

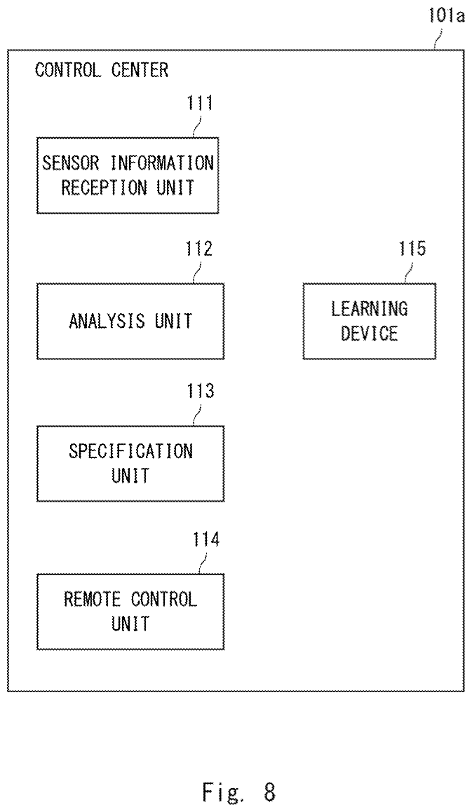

FIG. 8 illustrates a control center that is used in the present example embodiment. A control center 101a includes a learning device 115 in addition to the components illustrated in FIG. 3 of the control center 101. The learning device (a second learning device) 115 leans a rule (a second rule) relating to state information analyzed by the analysis unit 112. The learning device 115 learns, for example, a rule in which in a case where a large number of persons are present in a specified place, the persons in the specified place will move, and another place will be crowded. Alternatively, the learning device 115 learns a rule in which in a case where it is raining in a certain place, it will rain in another place. In the present example embodiment, the specification unit 113 may specify a control policy on the basis of the first rule and the second rule.

In the present example embodiment, the vehicle 150 includes the learning device 159 that learns a rule of automated driving. In addition, the control center 101 includes the learning device 115 that leans a rule relating to state information analyzed by the analysis unit 112. In the present example embodiment, the learning devices 115 and 159 are used, and therefore automated driving and the analysis of state information according to actual circumstances can be achieved. Other effects are similar to effects of the first example embodiment and the second example embodiment.

Note that in each of the example embodiments described above, the vehicle 200 may be a vehicle that is configured to be able to perform automated driving, similarly to the vehicle 150. In a case where the vehicle 200 is a vehicle that is configured to be able to perform automated driving, the control center 101 may determine that both the vehicle 150 and the vehicle 200 are vehicles to be controlled. In this case, the analysis unit 112 analyzes state information of the vehicle 150 and state information of the vehicle 200. The specification unit 113 specifies a control policy of the vehicle 150 on the basis of the state information of the vehicle 150, and specifies a control policy of the vehicle 200 on the basis of the state information of the vehicle 200. In analyzing the state information of the vehicle 200, information obtained by the sensor 201 is used as first information, and information obtained by the sensor 151 is used as second information.

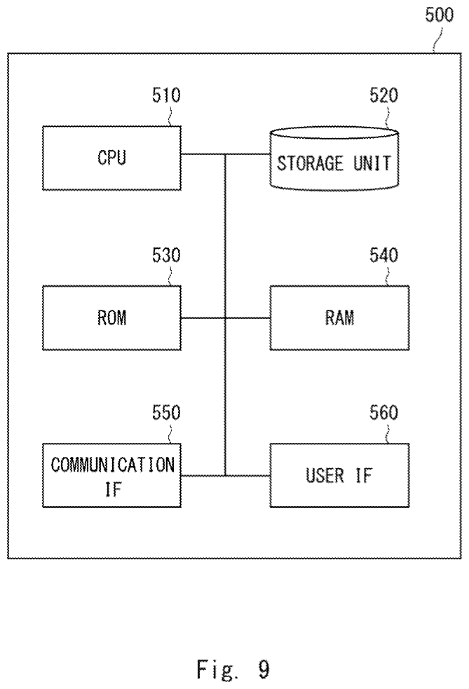

In the present disclosure, the control center 101 can be configured as a computer apparatus (a server apparatus). FIG. 9 illustrates an example of a configuration of a computer apparatus that can be used as the control center 101. A computer apparatus 500 includes a control unit (a central processing unit (CPU)) 510, a storage unit 520, a read only memory (ROM) 530, a random access memory (RAM) 540, a communication interface (IF) 550, and a user interface 560.

The communication interface 550 is an interface for connecting the computer apparatus 500 to a communication network by using wired communication means, wireless communication means, or the like. The user interface 560 includes, for example, a display unit such as a display. In addition, the user interface 560 includes an input unit such as a keyboard, a mouse, or a touch panel.

The storage unit 520 is an auxiliary storage device that can hold various types of data. The storage unit 520 does not necessarily need to be part of the computer apparatus 500, and may be an external storage device or a cloud storage connected to the computer apparatus 500 via a network.

The ROM 530 is a non-volatile storage device. As the ROM 530, for example, a semiconductor storage device, such as a flash memory, that has a relatively small capacity is used. A program executed by the CPU 510 can be stored in the storage unit 520 or the ROM 530. The storage unit 520 or the ROM 530 stores, for example, various programs for implementing a function of each unit in the control center 101.

The program described above can be stored by using various non-transitory computer-readable media, and can be supplied to the computer apparatus 500. The non-transitory computer-readable media include various tangible storage media. Examples of the non-transitory computer-readable medium include a magnetic recording medium such as a flexible disk, a magnetic tape, or a hard disk, a magneto-optical recording medium such as a magneto-optical disk, an optical disk medium such as a compact disc (CD) or a digital versatile disk (DVD), and a semiconductor memory such as a mask ROM, a programmable ROM (PROM), an erasable PROM (EPROM), a flash ROM, or a RAM. In addition, the program may be supplied to a computer by using various transitory computer-readable media. Examples of the transitory computer-readable medium include an electrical signal, an optical signal, and electromagnetic waves. The transitory computer-readable medium can supply the program to a computer via a wired communication line such as an electric wire or an optical fiber, or a wireless communication line.

The RAM 540 is a volatile storage device. As the RAM 540, various semiconductor memory devices, such as a dynamic random access memory (DRAM) or a static random access memory (SRAM), are used. The RAM 540 can be used as an internal buffer that transitorily stores data or the like. The CPU 510 deploys a program stored in the storage unit 520 or the ROM 530 in the RAM 540, and executes the deployed program. The CPU 510 executes the program, and therefore a function of each of the units in the control center 101 can be implemented. The CPU 510 may include an internal buffer in which data or the like can be transitorily stored.

Although example embodiments of the present disclosure has been described in detail above, the present disclosure is not limited to the example embodiment described above, and the present disclosure also includes those that are obtained by making changes or modifications to the example embodiment described above without departing from the spirit of the present disclosure.

For example, part or the entirety of the example embodiment disclosed above can be described as described in the following supplementary notes, but is not limited to the following.

### [Supplementary Note 1]

A vehicle control system including:

vehicle control means for controlling a target vehicle on the basis of first information obtained by a sensor that is provided in the target vehicle;

analysis means for analyzing state information of the target vehicle on the basis of the first information received via a network, and second information obtained from a sensor that is provided outside the target vehicle; and

specification means for specifying a control policy of the target vehicle on the basis of the state information analyzed by the analysis means.

### [Supplementary Note 2]

The vehicle control system according to Supplementary Note 1, in which the analysis means further analyzes the state information of the target vehicle on the basis of third information indicating information relating to an area where the target vehicle is present.

### [Supplementary Note 3]

The vehicle control system according to Supplementary Note 2, in which the third information includes information that affects traffic in the area where the target vehicle is present.

### [Supplementary Note 4]

The vehicle control system according to any one of Supplementary Notes 1 to 3, in which the state information includes an operation state of the target vehicle, and peripheral information of the target vehicle.

### [Supplementary Note 5]

The vehicle control system according to any one of Supplementary Notes 1 to 4, in which the control policy indicates a policy of automated driving.

### [Supplementary Note 6]

The vehicle control system according to any one of Supplementary Notes 1 to 5, further including a first learning device configured to learn a first rule relating to automated driving that is controlled by the vehicle control means, and a second learning device configured to learn a second rule relating to the state information analyzed by the analysis means, in which the specification means specifies the control policy on the basis of the first rule and the second rule.

### [Supplementary Note 7]

The vehicle control system according to any one of Supplementary Notes 1 to 6, further including control policy transmission means for transmitting the control policy that has been specified to the target vehicle,

in which the vehicle control means controls automated driving of the target vehicle on the basis of the control policy that has been transmitted.

### [Supplementary Note 8]

A vehicle control apparatus including:

analysis means for analyzing state information of a target vehicle on the basis of first information and second information, the target vehicle being controlled on the basis of the first information that has been obtained by a sensor that is provided in the target vehicle, the first information having been received via a network from the target vehicle, the second information having been obtained from a sensor that is provided outside the target vehicle; and

specification means for specifying a control policy of the target vehicle on the basis of the state information analyzed by the analysis means.

### [Supplementary Note 9]

The vehicle control apparatus according to Supplementary Note 8, in which the analysis means further analyzes the state information of the target vehicle on the basis of third information indicating information relating to an area where the target vehicle is present.

### [Supplementary Note 10]

The vehicle control apparatus according to Supplementary Note 9, in which the third information includes information that affects traffic in the area where the target vehicle is present.

### [Supplementary Note 11]

The vehicle control apparatus according to any one of Supplementary Notes 8 to 10, in which the state information includes an operation state of the target vehicle, and peripheral information of the target vehicle.

### [Supplementary Note 12]

The vehicle control apparatus according to any one of Supplementary Notes 8 to 11, in which the control policy indicates a policy of automated driving.

### [Supplementary Note 13]

The vehicle control apparatus according to any one of Supplementary Notes 8 to 12, in which

the target vehicle includes a first learning device configured to learn a first rule relating to automated driving,

the vehicle control apparatus further includes a second learning device configured to learn a second rule relating to the state information analyzed by the analysis means, and

the specification means specifies the control policy on the basis of the first rule and the second rule.

### [Supplementary Note 14]

A vehicle control method including:

analyzing state information of a target vehicle on the basis of first information and second information, the target vehicle being controlled on the basis of the first information that has been obtained by a sensor that is provided in the target vehicle, the first information having been received via a network from the target vehicle, the second information having been obtained from a sensor that is provided outside the target vehicle; and

specifying a control policy of the target vehicle on the basis of the state information that has been analyzed.

### [Supplementary Note 15]

The vehicle control method according to Supplementary Note 14, in which in the analyzing of the state information, the state information of the target vehicle is further analyzed on the basis of third information indicating information relating to an area where the target vehicle is present.

### [Supplementary Note 16]

The vehicle control method according to Supplementary Note 15, in which the third information includes information that affects traffic in the area where the target vehicle is present.

### [Supplementary Note 17]

The vehicle control method according to any one of Supplementary Notes 14 to 16, in which the state information includes an operation state of the target vehicle, and peripheral information of the target vehicle.

### [Supplementary Note 18]

The vehicle control method according to any one of Supplementary Notes 14 to 17, in which the control policy indicates a policy of automated driving.

### [Supplementary Note 19]

The vehicle control method according to any one of Supplementary Notes 14 to 18, in which

the target vehicle learns a first rule relating to automated driving,

the vehicle control method further includes learning a second rule relating to the state information analyzed in the analyzing of the state information, and

the specifying of the control policy includes specifying the control policy on the basis of the first rule and the second rule.

### [Supplementary Note 20]

A non-transitory computer-readable medium configured to store a program that causes a computer to perform a process including:

analyzing state information of a target vehicle on the basis of first information and second information, the target vehicle being controlled on the basis of the first information that has been obtained by a sensor that is provided in the target vehicle, the first information having been received via a network from the target vehicle, the second information having been obtained from a sensor that is provided outside the target vehicle; and

specifying a control policy of the target vehicle on the basis of the state information that has been analyzed.

### REFERENCE SIGNS LIST

10 VEHICLE CONTROL SYSTEM
11, 13 SENSOR
12 VEHICLE CONTROL MEANS
14 ANALYSIS MEANS
15 SPECIFICATION MEANS
16 CONTROL POLICY TRANSMISSION MEANS
100 VEHICLE CONTROL SYSTEM
101 CONTROL CENTER
102 NETWORK
111 SENSOR INFORMATION RECEPTION UNIT
112 ANALYSIS UNIT
113 SPECIFICATION UNIT
114 REMOTE CONTROL UNIT
115 LEARNING DEVICE
150 VEHICLE
151 SENSOR
152 PERIPHERY MONITORING SENSOR
153 VEHICLE SENSOR
154 VEHICLE CONTROL ECU
155 AUTOMATED DRIVING ECU
156 COMMUNICATION DEVICE
157 SENSOR INFORMATION TRANSMISSION UNIT
158 CONTROL POLICY RECEPTION UNIT
159 LEARNING DEVICE
200 VEHICLE
201 SENSOR
250 ON-ROAD FACILITY
251 SENSOR
300 EXTERNAL SERVER

What is claimed is:

1. A vehicle control system comprising:
at least one memory storing instructions, and
at least one processor configured to execute the instructions to:
control a target vehicle on the basis of first information obtained by a sensor that is provided in the target vehicle;
analyze state information of the target vehicle on the basis of the first information received via a network, and second information obtained from a sensor that is provided outside the target vehicle; and
specify a control policy of the target vehicle on the basis of the analyzed state information.

2. The vehicle control system according to claim 1, wherein the at least one processor is configured to execute the instructions to analyze the state information of the target vehicle on the basis of third information indicating information relating to an area where the target vehicle is present.

3. The vehicle control system according to claim 2, wherein the third information includes information that affects traffic in the area where the target vehicle is present.

4. The vehicle control system according to claim 1, wherein the state information includes an operation state of the target vehicle, and peripheral information of the target vehicle.

5. The vehicle control system according to claim 1, wherein the control policy indicates a policy of automated driving.

6. The vehicle control system according to claim 1, the at least one processor is further configured to execute the instructions to learn a first rule relating to automated driving of the target vehicle, and learn a second rule relating to the analyzed state information,
wherein the at least one processor is configured to execute the instructions to specify the control policy on the basis of the first rule and the second rule.

7. The vehicle control system according to claim 1, the at least one processor is further configured to execute the instructions to transmit the control policy that has been specified to the target vehicle,
wherein the at least one processor is configured to execute the instructions to control automated driving of the target vehicle on the basis of the control policy that has been transmitted.

8. A vehicle control apparatus comprising:
at least one memory storing instructions, and
at least one processor configured to execute the instructions to:
analyze state information of a target vehicle on the basis of first information and second information, the target vehicle being controlled on the basis of the first information that has been obtained by a sensor that is provided in the target vehicle, the first information having been received via a network from the target vehicle, the second information having been obtained from a sensor that is provided outside the target vehicle; and
specify a control policy of the target vehicle on the basis of the analyzed state information.

9. The vehicle control apparatus according to claim 8, wherein the at least one processor is configured to execute the instructions to analyze the state information of the target vehicle on the basis of third information indicating information relating to an area where the target vehicle is present.

10. The vehicle control apparatus according to claim 9, wherein the third information includes information that affects traffic in the area where the target vehicle is present.

11. The vehicle control apparatus according to claim 8, wherein the state information includes an operation state of the target vehicle, and peripheral information of the target vehicle.

12. The vehicle control apparatus according to claim 8, wherein the control policy indicates a policy of automated driving.

13. The vehicle control apparatus according to claim 8, wherein
a first rule relating to automated driving of the target vehicle is learned,
the at least one processor is further configured to execute the instructions to learn a second rule relating to the analyzed state information, and
the at least one processor is configured to execute the instructions to specify the control policy on the basis of the first rule and the second rule.

14. A vehicle control method comprising:
analyzing state information of a target vehicle on the basis of first information and second information, the target vehicle being controlled on the basis of the first information that has been obtained by a sensor that is provided in the target vehicle, the first information having been received via a network from the target vehicle, the second information having been obtained from a sensor that is provided outside the target vehicle; and
specifying a control policy of the target vehicle on the basis of the state information that has been analyzed.

15. The vehicle control method according to claim 14, wherein in the analyzing of the state information, the state information of the target vehicle is further analyzed on the basis of third information indicating information relating to an area where the target vehicle is present.

16. The vehicle control method according to claim 15, wherein the third information includes information that affects traffic in the area where the target vehicle is present.

17. The vehicle control method according to claim 14, wherein the state information includes an operation state of the target vehicle, and peripheral information of the target vehicle.

18. The vehicle control method according to claim 14, wherein the control policy indicates a policy of automated driving.

19. The vehicle control method according to claim 14, wherein
the target vehicle learns a first rule relating to automated driving,
the vehicle control method further includes learning a second rule relating to the state information analyzed in the analyzing of the state information, and
the specifying of the control policy includes specifying the control policy on the basis of the first rule and the second rule.

20. (canceled)
